(19) United States
(12) Patent Application Publication
(10) Pub. No.: US 2015/0155114 A1
(43) Pub. Date: Jun. 4, 2015

(54) SWITCH

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YAN-BANG CAO, Shenzhen (CN)

(21) Appl. No.: 14/528,603

(22) Filed: Oct. 30, 2014

(30) Foreign Application Priority Data
Nov. 30, 2013 (CN) 201320769389.7

(51) Int. Cl. H01H 9/04

(52) U.S. Cl. CPC H01H 9/04; H01H 2223/002

(57) ABSTRACT

A switch is provided. The switch includes a circuit board, a triggering board, a metal sheet, and a head portion. The circuit board includes a number of conductive pins. The triggering board is positioned on the circuit board, and includes a negative conductive tray electrically coupled with the plurality of conductive pins and two positive conductive sheets situated at two ends of the negative conductive tray. The metal sheet is positioned above the negative conductive tray and the two positive conductive sheets, and is engaged with two sidewalls of the triggering board. The head portion is located on the metal sheet.

### CROSS-REFERENCE TO RELATED APPLICATIONS

This application claims priority to Chinese Patent Application No. 201320769389.7 filed on Nov. 30, 2013, the contents of which are incorporated by reference herein.

### FIELD

The present disclosure relates to switch devices, and particularly to a switch having a structure of preventing dust from entering inside of an electronic device.

### BACKGROUND

Dust easily enters electronic devices through a space formed by switches and contact points of the electronic devices.

### BRIEF DESCRIPTION OF THE DRAWINGS

Implementations of the present technology will now be described, by way of example only, with reference to the attached figures.

FIG. 1 is an isometric view of a switch.

FIG. 2 is an exploded view of the switch of FIG. 1.

FIG. 3 is a cross-sectional view of the switch of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

Embodiments of the present disclosure will be described with reference to the accompanying drawings.

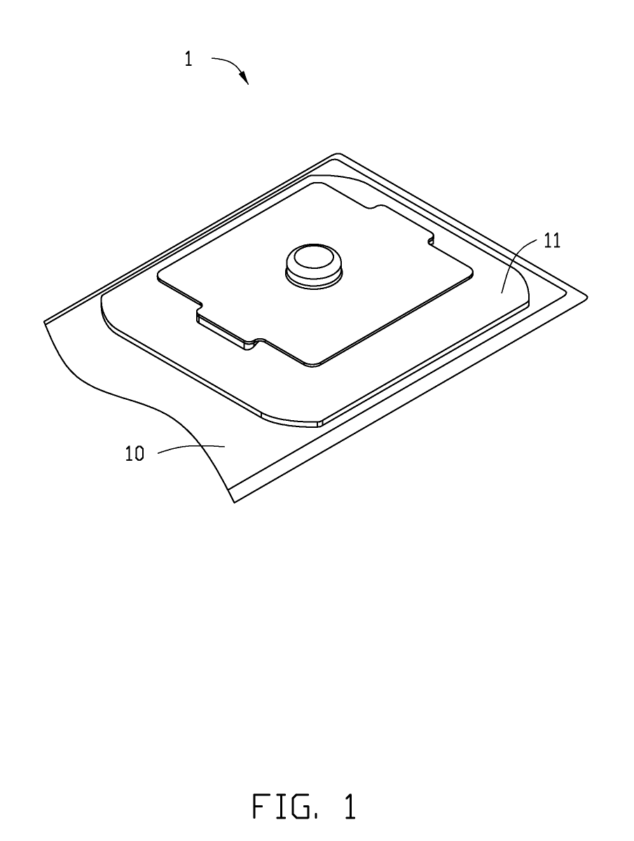

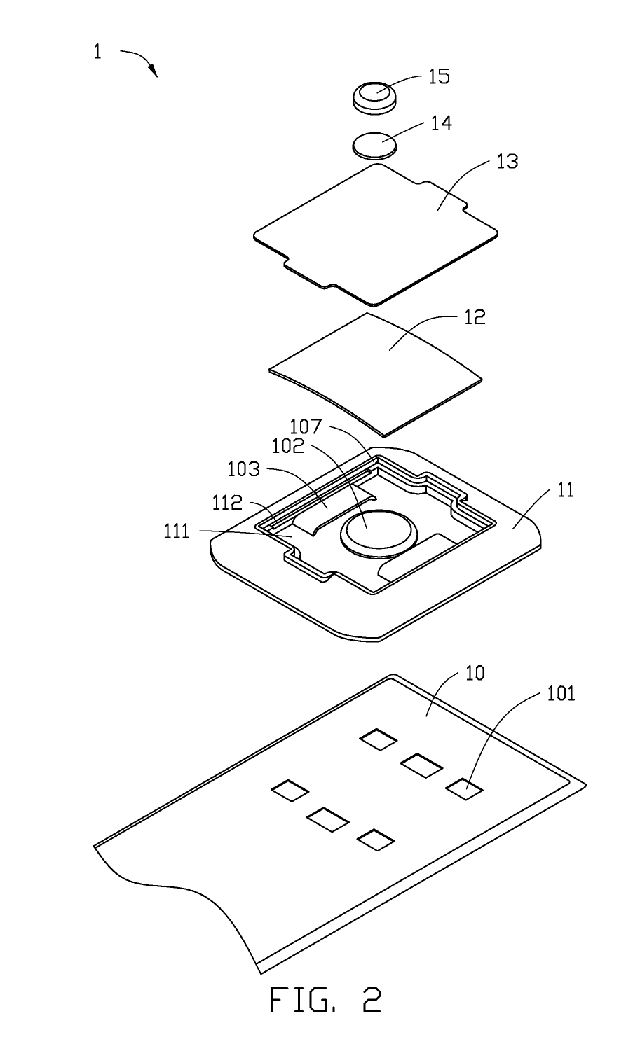

FIG. 1 illustrates a switch 1. The switch 1 includes a circuit board 10, and a triggering board 11 positioned on the circuit board 10. Referring to FIG. 2, the triggering board 11 includes a negative conductive tray 102 and two positive conductive sheets 103 placed at opposite ends of the negative conductive tray 102. The circuit board 10 includes a number of conductive pins 101 electrically coupled with the negative conductive tray 102. The switch 1 further includes a metal sheet 12 positioned above the negative conductive tray and the two positive conductive sheets, and engaged with two sidewalls 107 of the triggering board 11, and a head portion 15 placed on the metal sheet 12. When operating the switch 1, the head portion 15 is forced to press the metal sheet 12 to contact with the positive conductive sheets 103 and the negative conductive tray 102, thereby electrically connecting the negative conductive tray 102 and the two positive conductive sheets 103 through the metal sheet 12. After the negative conductive tray 102 electrically connects with the two positive conductive sheets 103, it generates a connecting signal which is transmitted to the circuit board 10 through the conductive pins 101. In at least one embodiment, the head portion 15 is made of plastic material.

The triggering board 11 defines a recessed portion 111. The negative conductive tray 102 and the two positive conductive sheets 103 are coupled with a bottom of the recessed portion 111. The two opposite sidewalls 107 of the recessed portion 111 forms two stepping portions 112 above the two positive conductive sheets 103. Two opposite ends of the metal sheet 12 are placed on the two stepping portions 112, thereby engaging the metal sheet 12 with the triggering board 11.

The switch 1 can further include a film 13 and an adhesive 14. The film 13 is fixed on a top surface of the metal sheet 12. The head portion 15 is adhered on the film 13 through the adhesive 14. The film 13 can be configured to create a good seal, thereby preventing dust from entering the inside of the electronic device through the film 13. In at least one embodiment, the film 13 is a polyester (PET) film. The adhesive 14 can be a pressure sensitive adhesive (PSA).

When assembling the switch 1, the triggering board 11 is placed on the circuit board 10, the negative conductive tray 102 and the two positive conductive sheets 103 are fixed on the triggering board 11. The metal sheet 12 is placed on the two stepping portions 112, the film 13 is fixed on the metal sheet 12. The head portion 15 is adhered on the film 13 through the adhesive 14.

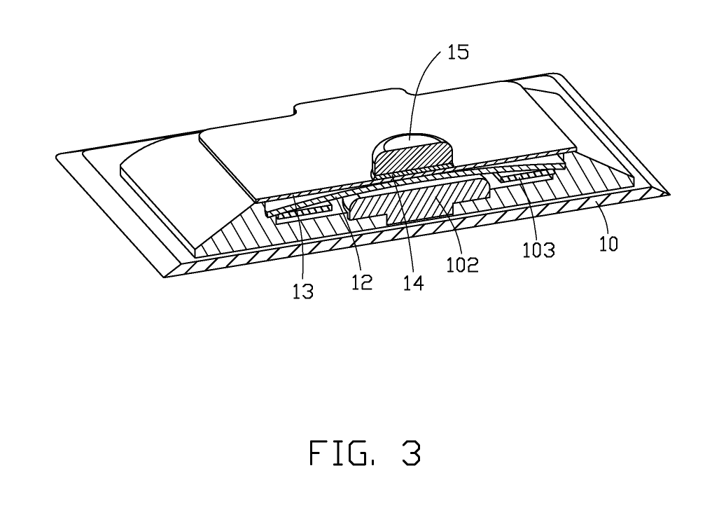

Referring to FIG. 3, when operating the switch 1, the head portion 15 is forced to press the metal sheet 12 to contact with the positive conductive sheets 103 and the negative conductive tray 102, thereby electrically connecting the negative conductive tray 102 and the two positive conductive sheets 103. After the negative conductive tray 102 electrically connects with the two positive conductive sheets 103, it generates the connecting signal which is transmitted to the circuit board 10 through the conductive pins 101. The circuit board 10 transmits the connecting signal to an external electronic device to execute a corresponding function.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A switch comprising:
a circuit board comprising a plurality of conductive pins;
a triggering board positioned on the circuit board, the triggering board comprising a negative conductive tray electrically coupled with the plurality of conductive pins and two positive conductive sheets situated at two ends of the negative conductive tray;
a metal sheet positioned above the negative conductive tray and above the two positive conductive sheets, the metal sheet engaged with two sidewalls of the triggering board; and
a head portion located on the metal sheet.

2. The switch as described in claim 1, wherein the triggering board defines a recessed portion, the negative conductive tray and the two positive conductive sheets are coupled with a bottom of the recessed portion, two opposite sidewalls of the recessed portion form two stepping portions, the metal sheet is placed on the two stepping portions to engage the metal sheet with the triggering board.

3. The switch as described in claim 2, further comprising:
a film coupled with a top surface of the metal sheet.

4. The switch as described in claim 3, further comprising:
an adhesive; and
the head portion being adhered on the film by the adhesive.

5. The switch as described in claim 4, wherein the adhesive is a pressure sensitive adhesive.

6. The switch as described in claim 3, wherein the film is a polyester film.
